(19) United States
(12) Patent Application Publication
(10) Pub. No.: US 2008/0230591 A1
(43) Pub. Date: Sep. 25, 2008

(54) DEVICE AND METHOD FOR PRETREATING ELECTRONIC COMPONENTS PRIOR TO SOLDERING

(76) Inventors: Ernst Wandke, Geretsried (DE); Klaus W. Gerstenberg, Halstenbek (DE)

Correspondence Address: The BOC Group, Inc., 575 MOUNTAIN AVENUE, MURRAY HILL, NJ, 07974-2082, US

(21) Appl. No.: 12/044,283

(22) Filed: Mar. 7, 2008

(30) Foreign Application Priority Data
Mar. 20, 2007 (DE) 102007013326.1
Jun. 28, 2007 (EP) 07012718.8

(51) Int. Cl. B23K 1/20; B23K 3/08

(52) U.S. Cl. 228/203; 228/52

(57) ABSTRACT

A device and method are provided for reflow soldering workpieces wherein a plasma device for an atmospheric plasma treatment of the workpiece is upstream of a solder application and/or upstream of a soldering zone, and wherein the method subjects the workpiece to an atmospheric plasma treatment with the aid of a plasma device prior to the application of the solder and/or prior to the soldering process.

### BACKGROUND OF THE INVENTION

The present invention pertains to a device for reflow soldering workpieces with a solder application and a method for reflow soldering.

The term reflow soldering refers to a known soldering method that is frequently utilized, for example, in electrical engineering. This method is characterized in the application of solder prior to populating the workpiece, e.g., a printed board or a circuit board, with the components to be soldered thereon. Numerous options are available for applying the solder onto the workpiece. It is preferred to utilize a soldering paste that is printed on, e.g., by means of a screen printing method. However, the solder can also be applied with a dispenser, with solder preforms or in a galvanic fashion.

After populating the workpiece with the components, the populated workpiece is heated in order to carry out the actual soldering process. Numerous options are also available for heating the workpieces, e.g., heating by means of a heating plate, heated preforms, infrared radiators or laser radiation. One exception in this respect is vapor phase soldering that can also be categorized as a reflow soldering method and in which the workpiece is heated due to the condensation of a vapor on the workpiece, as well as the transfer of its condensation heat to the workpiece.

### BRIEF DESCRIPTION OF THE DRAWINGS

The invention as well as embodiments thereof are described in greater detail below with reference to the embodiments illustrated in the Figures, of which:

FIG. 1 shows reflow soldering with a plasma device prior to the application of soldering paste;

FIG. 2 shows reflow soldering with a plasma device upstream of the soldering zone; and

FIG. 3 shows reflow soldering with a plasma device prior to the application of soldering paste and upstream of the soldering zone.

### DETAILED DESCRIPTION OF THE INVENTION

The present invention is based on improving the attainable soldering quality during reflow soldering.

With respect to the device, a plasma device 5 for an atmospheric plasma treatment of the workpiece is provided upstream of the solder application and/or upstream of the soldering zone. One suitable plasma device generates a so-called atmospheric pressure plasma. In contrast to a low-pressure plasma, such a plasma device is suitable for use within the atmospheric pressure range. In the following description, the term atmospheric pressure plasma refers to a plasma present at a pressure that deviates from the ambient pressure by no more than 200 mbar, i.e., at the ambient pressure ±200 mbar. The atmospheric pressure plasma is generated, in particular, in a pressure range between 800 mbar and 1200 mbar.

A low-temperature atmospheric pressure plasma proved particularly suitable in this respect. In this context, the term low-temperature refers to temperatures below 300° C., preferably temperatures in the range between room temperature and 250° C. It is advantageous that a vacuum chamber as well as the corresponding devices for generating and maintaining a vacuum can be eliminated. This represents a decisive improvement that makes the utilization of a plasma device for reflow soldering much more attractive.

It was determined that the plasma treatment advantageously improves the wetting properties between the solder and the workpiece and between the molten metal bath and the workpiece. Each of these two measures improves the soldering quality individually, as well as in combined form.

The solder application is realized in the form of a soldering paste application or an application of punchings containing solder is provided. Such punchings are also referred to as preforms.

The plasma device is designed such that it is suitable for producing a plasma flame. Numerous options are also available in this respect, wherein several of these options are described in an exemplary fashion below.

According to one embodiment of the invention, the plasma device features at least two electrodes. Consequently, the plasma device can be used, e.g., for a free direct discharge or a controlled discharge. In this case, the free electric discharge is controlled by external conditions only while the controlled electric discharge can also be actively controlled, e.g., by regulating the power supply. This type of plasma generation also includes the so-called plasma-jet and the arc discharge.

According to another embodiment of the invention, at least one of the electrodes is coated with a dielectric. Consequently, this embodiment makes it possible to respectively realize a barrier discharge and a corona discharge. For example, a corona discharge is particularly suitable for all applications, in which the potential-free state is not an important aspect.

It is advantageous if the plasma device is designed such that it is suitable for generating an essentially potential-free plasma discharge. For example, a potential-free plasma that is supplied with a medium-frequency voltage with a power of 200 W and features a nitrogen feed system or a feed system for a nitrogen-hydrogen mixture with a flow of approximately 20 l/min proved advantageous. The frequency, the power, the type of gas, the composition of a gas mixture and the gas flow can be selected from a broad spectrum and adapted to the respective application.

It is advantageous that the plasma device features a supply system for a process gas that serves for generating the plasma flame. For example, compressed air or a reducing gas may be used as the process gas. Forming gas, i.e., a mixture of N₂ and H₂ in a ratio of 95:5, proved advantageous.

For certain applications, however, it may be advantageous to utilize a gas or a gas mixture that acts in an oxidizing fashion. For example, a mixture of N₂ and/or argon with oxygen, CF₄ or CO₂ may provide advantages in this respect.

The plasma device features a transport system that makes it possible to move the plasma flame. For example, good results were obtained with treatment speeds in the range between 1 and 20 m/min.

According to one development of the invention, a plasma device suitable for simultaneously generating several plasma flames is provided.

According to another embodiment of the invention, two or more plasma devices are provided.

One or more plasma devices is/are realized and/or arranged such that a two-sided plasma treatment can be carried out, particularly on respectively opposite sides such as, for example, on the upper side and the lower side of the workpiece.

In another embodiment of the invention, an encapsulation surrounding the soldering zone is provided. This embodiment provides the present invention with all advantages of soldering under an inert gas and/or active gas atmosphere. In this case, there is provided a device for introducing an inert gas and/or active gas atmosphere into the region of the soldering zone.

With respect to the method, the workpiece is subjected to an atmospheric plasma treatment with the aid of a plasma device prior to the application of the solder and/or prior to the soldering process.

Soldering paste is applied onto the workpiece as the first process step.

According to another embodiment of the invention, punchings containing solder are applied onto the workpiece.

A plasma flame is generated with the aid of the plasma device.

An electric discharge between two electrodes is utilized for generating the plasma flame. This means that a free electric breakdown is used for the plasma generation in the above-described fashion.

According to another embodiment of the invention, the plasma flame is produced by utilizing an electric discharge between two electrodes, wherein one of the electrodes is coated with a dielectric. This means that, e.g., a barrier or corona discharge is used for generating the plasma. The utilization of a corona discharge is suggested, in particular, if the plasma does not have to be potential-free for the respective application.

A process gas is utilized for producing the plasma flame. For example, compressed air or a reducing gas is suitable for use as the process gas.

A gas or a gas mixture that acts in a reducing fashion is utilized as the process gas. For example, a mixture of N₂ and H₂ is suitable for use as a reducing gas or gas mixture. Forming gas, i.e., a mixture of N₂ and H₂ in a ratio of 95:5, proved suitable in this respect. However, the utilization of a gas or gas mixture that acts in an oxidizing fashion may be advantageous for certain applications. For example, a mixture of N₂ and/or argon with oxygen, CF₄ or CO₂ may provide certain advantages in this respect.

It is advantageous to utilize a potential-free plasma.

The plasma device is moved with the aid of a transport system. For example, good results were obtained with treatment speeds in the range between 1 and 20 m/min.

Several plasma flames may be used for treating the workpiece. A two-sided plasma treatment may be carried out, particularly on respective opposite sides such as, for example, on the upper side and the lower side of the workpiece.

According to an additional development of the invention, an inert gas and/or active gas is introduced into the region of the soldering zone. In this development, the present invention also utilizes all advantages of soldering under an inert gas and/or active gas atmosphere.

The invention provides numerous advantages, of which only a few are listed as examples below:

The soldering quality is significantly improved. This improvement appears to be achieved due to the superior wetting properties. In addition, the required reworking and recleaning of the soldered workpieces is substantially reduced because the invention makes it possible to significantly reduce the adhesion of undesirable depositions on the individual workpieces. This leads to cost savings in comparison with conventional soldering devices and methods. The invention also reduces the required maintenance work on the soldering systems. The invention makes it possible to utilize soldering pastes with a lower degree of acidity or a lower flux content than conventional soldering pastes.

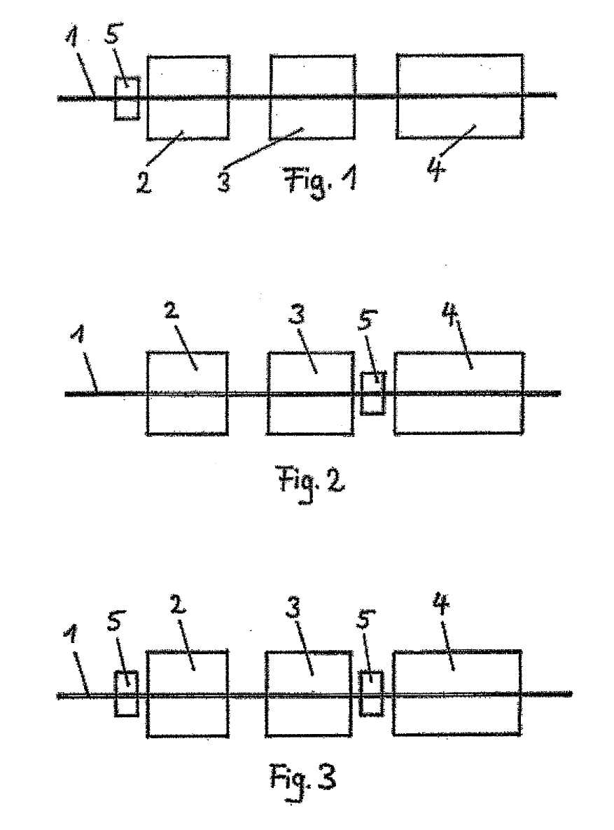

FIG. 1 shows, in particular, a transport system 1 that successively transports the workpieces (not-shown) to a soldering paste application 2, an insertion device 3 and ultimately a soldering zone 4. The soldering zone 4 features a device (not-shown) for heating the workpieces. In FIG. 1, a plasma device 5 is illustrated upstream of the soldering paste application 2, wherein said plasma device 5 serves for subjecting each workpiece to a plasma treatment prior to the application of soldering paste. For example, suitable plasma devices are the Plasma-Blasters MEF of the firm Tigres that are able to generate a potential-free atmospheric pressure plasma.

Although FIG. 2 also shows the elements described above with reference to FIG. 1, the plasma device 5 is not arranged upstream of the soldering paste application 2, but rather upstream of the soldering zone 4.

FIG. 3 shows a combination of the above-described embodiments, wherein a plasma device 5 is respectively provided prior to the soldering paste application 2 as well as upstream of the soldering zone 4.

In all three embodiments, soldering paste is initially applied onto the workpiece and the workpiece is subsequently populated with the components to be soldered thereon, wherein the populated workpiece is subsequently introduced into a soldering zone 4 and subjected to the soldering process by heating the populated workpiece. The workpiece is subjected to a plasma treatment with the aid of the plasma device 5 prior to the application of the soldering paste and/or prior to the soldering process. The plasma treatment is carried out at a pressure between 900 and 1100 mbar.

It will be understood that the embodiments described herein are merely exemplary and that a person skilled in the art may make many variations and modifications without departing from the spirit and scope of the invention. All such variations and modifications are intended to be included within the scope of the invention as defined in the appended claims. It should be understood that the embodiments described above are not only in the alternative, but can be combined.

What is claimed is:

1. An improved device for reflow soldering workpieces of the type having a solder paste application, an insertion device for populating the workpiece with components to be connected to the workpiece by means of a soldering process, and a soldering zone in which the soldering process is carried out by heating the populated workpiece, wherein the improvement comprises:
a plasma device disposed for providing an atmospheric plasma treatment to the workpiece prior to the solder paste application and/or upstream of the soldering zone.

2. The improved device according to claim 1, wherein the plasma device produces a plasma flame.

3. The improved device according to claim 2, wherein the plasma device comprises a transport system to move the plasma flame.

4. The improved device according to claim 1, further comprising one or more plasma devices disposed to provide the plasma treatment on two sides of the workpiece.

5. The improved device according to claim 4, wherein the two sides are opposed sides of the workpiece.

6. In a method of reflow soldering workpieces, of the type wherein solder is initially applied onto a workpiece and the workpiece is subsequently populated with the components to be soldered thereon, and the populated workpiece is introduced into a soldering zone in which it is subjected to a soldering process by heating the populated workpiece, the improvement comprising:
subjecting the workpiece to an atmospheric plasma treatment from a plasma device prior to the application of the solder to the workpiece and/or prior to the soldering process.

7. The improved method according to claim 6, further comprising applying punchings containing solder onto the workpiece.

8. The improved method according to claim 6, wherein the atmospheric plasma treatment further comprises producing a plasma flame by adding a process gas, wherein the process gas is selected from a gas and a gas mixture that acts in a reducing fashion.

9. The improved method according to claim 6, wherein the atmospheric plasma treatment comprises using a potential-free plasma.

10. The improved method according to claim 6, wherein the atmospheric plasma treatment comprises using a plurality of plasma flames for treating the work piece.

11. The improved method according to claim 6, further comprising providing the atmospheric plasma treatment on two sides of the workpiece.

12. The improved method according to claim 11, wherein the two sides are opposed sides of the workpiece.
